(19) United States
(12) Patent Application Publication
(10) Pub. No.: US 2024/0251818 A1
(43) Pub. Date: Aug. 1, 2024

(54) Food Decorating Stencil

(71) Applicant: Claudiney Santos Borges, Spencer, MA (US)

(72) Inventor: Claudiney Santos Borges, Spencer, MA (US)

(21) Appl. No.: 18/102,092

(22) Filed: Jan. 27, 2023

(51) Int. Cl. A23G 3/28

(52) U.S. Cl. CPC A23G 3/28

(57) ABSTRACT

A novel method of decorating food items particularly baked items with pre-designed stencils to ease the process of food decoration. The proposed stencils are easy to use, require no training, quick to implement, and need no special tools or ingredients to complete the look.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to a method of decorating an edible article, for example, a cake, and more particularly relates to stencil designs selected by theme and can be easily formed by spraying edible paints by any person without professional or specialized knowledge.

### Description of the Related Art

The vast majority of prior art relating to decorating confections and baked goods concerns means and methods for forming three-dimensional decorations and designs, usually by the application of additional foodstuffs such as icings and the like, which are formed into the desired configuration. In a few instances the prior art discloses the application of two-dimensional designs through the use of colored inks, food dyes, and the like which are transferred to the surface of previously-cooked baked goods or confections. One example of such prior art in U.S. Pat. No. 4,024,287-Golchert in which it is disclosed that a design which has been hand-formed upon a porous transfer medium can be subsequently transferred to the surface of a cake or other pre-cooked food item. Typically, with this process designs are created by the person using the method so that the newly-prepared transfer is available for application to the confection.

One major disadvantage of such prior art approaches is that few people are sufficiently talented to hand-make a sufficiently attractive design, even if a process of tracing is resorted to. This is particularly true in the case of children. With such approaches intricate or detailed designs, multiple color designs or shading effects are extremely difficult to achieve.

Another, and even more significant, disadvantage of such prior art approaches is that they are practiced only in a final or finishing step, as they are applied to pre-cooked items such as a cake or the like. The porous nature of some cooked food items may be prone to blur the design; and further, no means is taught whereby such a design can be permanently fixed on the surface of the food item. Indeed, if an attempt is made to cover such a design with, for instance, a protective coating, the coating material will typically dissolve the ink forming the design and cause it to smear or blur.

A second prior art approach is found in U.S. Pat. No. 3,537,406 Ort, for “Decorating Bread Products.” Ort discloses applying designs to baked goods by silk-screening edible inks onto “half-proof” (i.e. partially risen) rolls or breads. This method suffers from the drawback that silk-screening permits but one color ink to be applied at a time; therefore, if it is desired to decorate a baked good with a multicolored design, several different silkscreens must be made, and a corresponding number of inking steps must be employed. In order to ensure proper registration of the several inks, so that they are each in the proper places with respect to one another, elaborate measures (complicated by the amorphous nature of dough and variations in size from one roll or loaf to the next) must be undertaken, all adding to the complexity, difficulty and expense of the operation.

By looking at prior art there are multiple solutions that are presented bringing advancement in decorating food items. However, these solutions are limited and restricted to their complicated methods, application expertise, and pre-requirements and have considerable shortcomings which adversely affect the convenience with which they can be used by any untrained person. It has to be noted that the current invention proposes an assembly with an advancement where the proposed system teaches an improved method for forming designs upon certain food products.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for forming designs upon food products.

Another object of the present invention is to provide a method whereby complex or intricate designs may easily be formed on baked goods.

It is a more particular object of the present invention to provide stencils that are designed to suit various themes and are easy to use.

It is also the objective of the invention to provide whereby a transfer design that may be fixed on the surface of a food product for improved finishing.

It is further the objective of the invention to provide a method of decorating baked goods that may be practiced by hand easily and require no special equipment and training.

Thus, it is the objective to provide a new and improved form of apparatus to decorate baking goods with stencils designed to facilitate various themes. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a complete working view of the apparatus showing my new assembly.

FIG. 1 is an overview from the top right of the food stencil showing my new assembly.

FIG. 2 is a top view of the food stencil.

FIG. 3 is a bottom flat view of the food stencil.

FIG. 4 is a side flat view of the food stencil.

FIG. 5 is a view from the top right of the food stencil over the food/pancake.

FIG. 6 shows the edible paint spray over the stencil and food

FIG. 7 is an overview for from the top right of the food stencil.

FIG. 8 is an edible paint spray over a stencil and food.

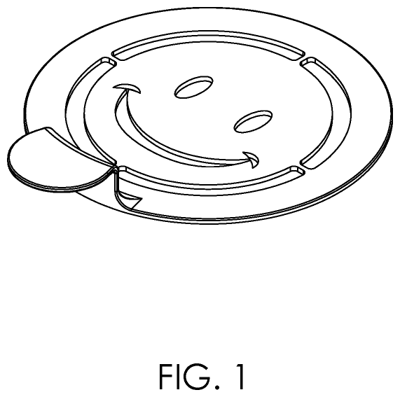

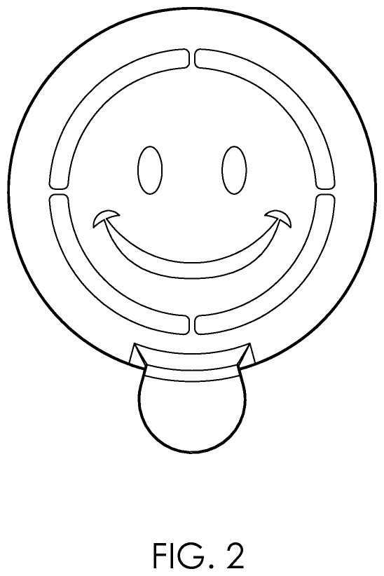

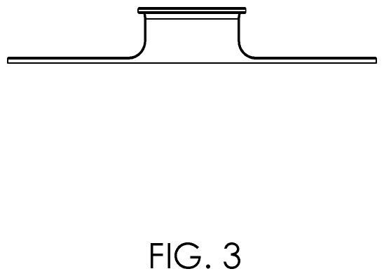

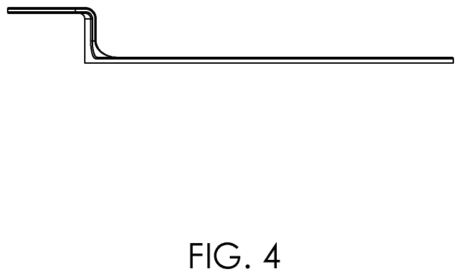

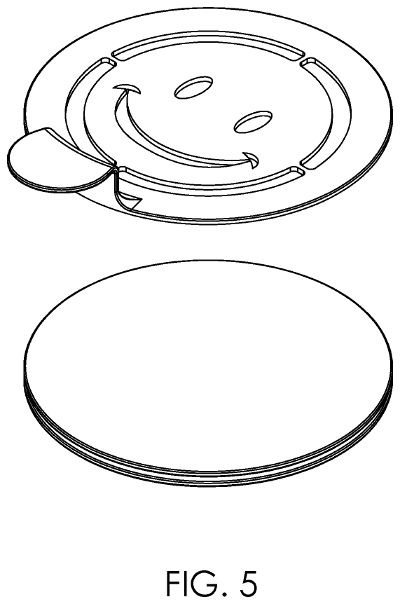

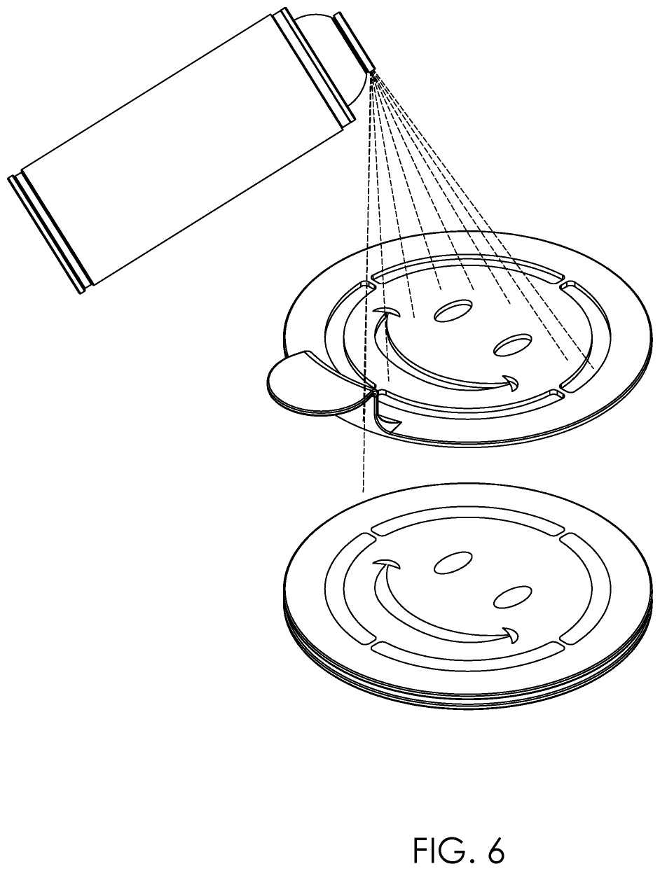

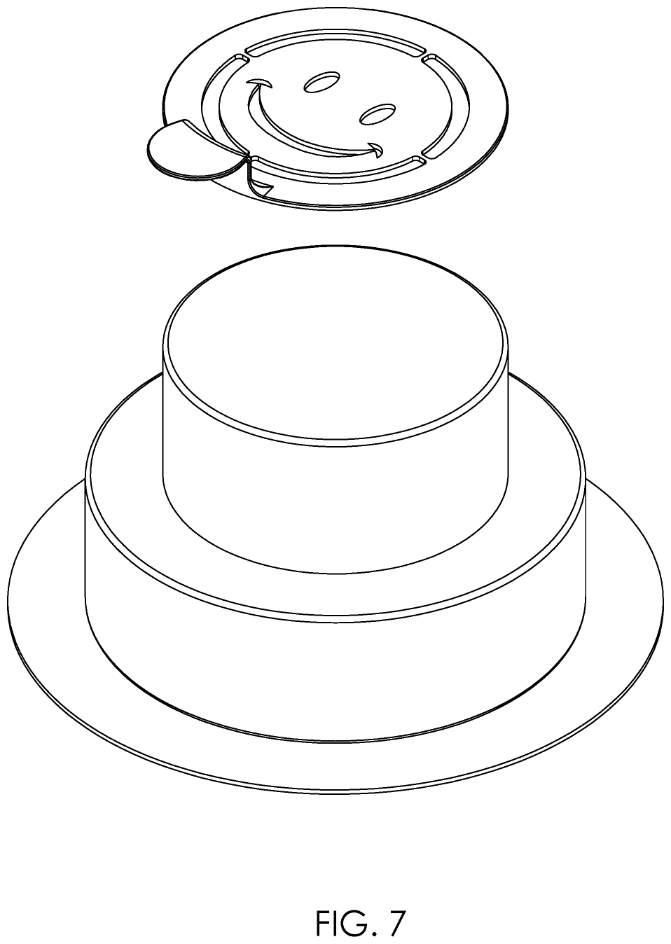

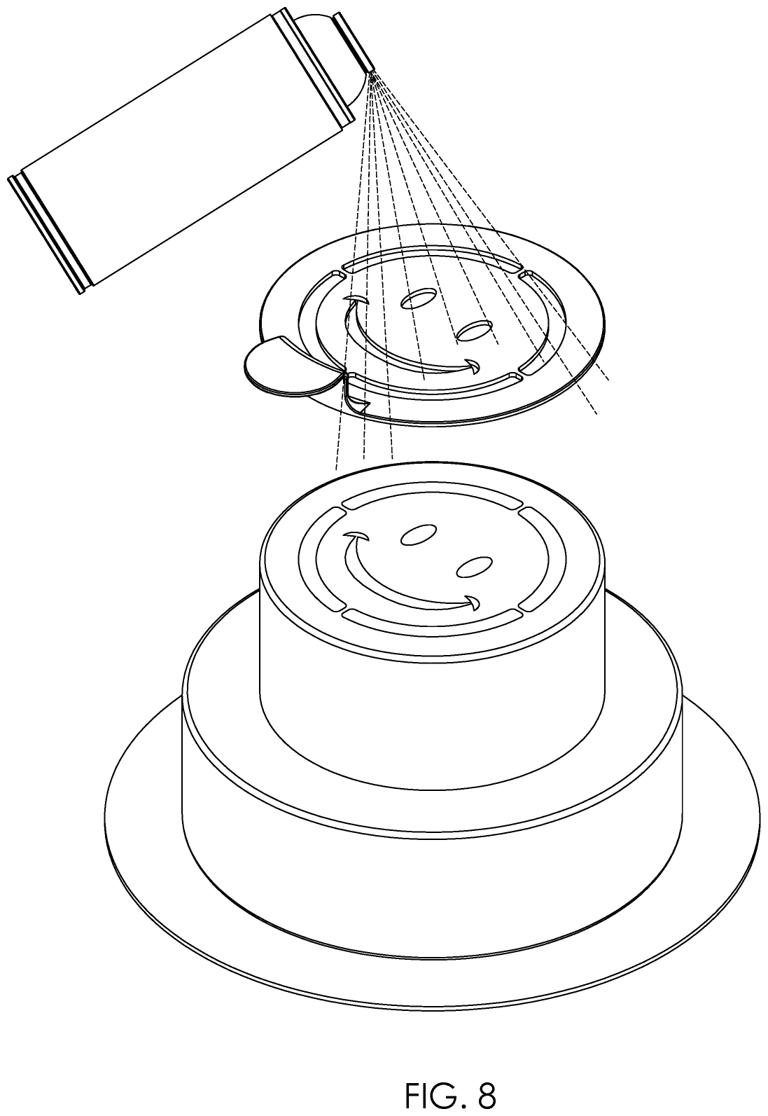

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In one embodiment, an enhanced structure of stencils which are used to form various types of shapes and words by spraying edible food spray on them.

In another embodiment, a process for producing decorative baked good items includes using illustration placement applicators also called stencils, which places symbol and or decoration on the surface of a food product. A variety of symbols, numbers, lettering or designs can be printed on top of the assembly by spraying the food spray on the stencils.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method of applying decorative edible designs and or symbols, comprising alpha/numeric, wherein said symbols and designs are applied to the surface of a prepared food product, said method comprising steps of:
applying an illustration that comprises a design and or symbols, wherein the illustration is applied by way of stencils/illustration applicators, wherein said stencils/illustration applicators are positioned on the surface of said food product and edible food spray is done on top of stencils/illustration applicator.

2. The method as in claim 1, wherein said stencils/illustration applicators include a variety of designs of stencils to accommodate various themes.

3. The method as in claim 1, wherein said illustration applicators include stencil applicators to create designs by allowing food spray or powder to enter into the openings of the stencils to allow the application of said spray or powder on to the food products surface.

4. The method as in claim 1, wherein said stencil applicators include a screen across the openings of the stencils to aid in the even distribution of the granules or powder in the openings of the stencils.

5. The method as in claim 1, further includes the step of a spray/powder spreader being drawn across the top of the stencil applicator, evening the granules or powder in the openings of the stencils.
